(19) United States
(12) Patent Application Publication
(10) Pub. No.: US 2002/0143791 A1
(43) Pub. Date: Oct. 3, 2002

(54) Content deployment system, method and network

(76) Inventors: Dov Levanon, Hod Hasharon (IL); Ezer Goshen, Or Yehuda (IL); Il Ya Kushnirsky, Nes Ziona (IL)

Correspondence Address: Y. ROCKY TSAO, Fish & Richardson P.C., 225 Franklin Street, Boston, MA, 02110-2804, US

(21) Appl. No.: 09/812,233

(22) Filed: Mar. 19, 2001

(51) Int. Cl. G06F 7/00

(52) U.S. Cl. 707/200

(57) ABSTRACT

A broadband system (20) provides access to content to a number of user terminals (30, 35, 40). The system stores the content and has a database (22) of information, at least some of which information concerns the content. The system (20) allows access by user terminals (30, 35, 40) to the content in dependence on the information. The system (20) receives new or updated content with associated metadata, the metadata containing data on the new or updated content, the system (20) being arranged to store information derived from the metadata in the database (22) for the received new or updated content, thereby allowing access to the content by user terminals (30, 35, 40).

### FIELD OF THE INVENTION

The present invention relates to a system and method suitable for the deployment of content for broadband service systems.

### BACKGROUND TO THE INVENTION

Broadband access networks such as xDSL, cable TV and fixed wireless networks that provide multiple channels of data over a single communication medium are becoming increasingly widespread. Until recently, broadband access providers have focused on using their networks to provide high speed Internet access. In the case of ADSL, the high bandwidth downlink and limited bandwidth uplink available is ideal for typical Internet users who spend most of their time receiving data and very little transmitting.

It has recently been realised that this is also the case for most multimedia content provision and associated services provided to users and businesses. Content such as video, music, games and the like is desirable on an on-demand basis to users homes and to businesses. Whilst television and radio broadcasts are popular due to the variation in content, many users wish to be able to receive content based on their schedule and lifestyle. This demand is reflected by the popularity of video rental as opposed to going to the cinema. With a video, you are in control of when the movie is played, paused etc. Therefore there are an increasing number of parties interested in providing this content and associated services in an on-demand basis.

Although on-demand service provision has been attempted over the Internet, the bottlenecks and unreliability of the Internet has prevented such services being provided to mainstream audiences. Realising that broadband networks offer the quality of service and reliable availability of bandwidth that the Internet lacks, broadband network providers are now developing on-demand services. The services are intended to provide multi media services and content to end users and businesses over the networks.

Broadband service systems are being provided in broadband networks to offer such content and services. Users logon to the system via terminals in their homes or businesses and can access the content and services offered by the system through a user interface. Broadband service systems implemented to date vary from basic computer servers to complex computer systems incorporating specific hardware for video streaming, telecommunications and the like.

The user interface provided by the broadband service systems to user terminals is normally designed to offer simple, user friendly access to the content and services. The user interface is commonly in the form of pages of text and menus that can be navigated using a simple control device such as a television remote control. In order to keep the interface simple and easy to use, the interface is specifically written for the content and services provided by the computer system. Because many of the broadband network access providers are also attempting to be service and content providers, they have access to all the network hardware including the broadband service systems and can make the necessary changes to the user interface if the content or services change.

Where an outside party wishes to be a content provider and/or a service provider, he or she must provide the content and services to the network access provider who integrates them into the user interface of their broadband service systems. This arrangement results in a large amount of work for the network access provider in maintaining and supporting the system and limits the flexibility that can be offered to content and service providers in terms of their contents and services. The user sees this as delays in the availability of new content and services and increased downtime whilst services are being updated.

Even where an outside party reaches an agreement with a network access provider for the third party to install and support his own broadband service system in the broadband network to provide content and services, because the user interface is written specifically for the content and services offered, integration of new content and services is complex and time consuming and results in different computer systems being provided for different services from the same or different service providers. From a user's point of view, a number of user interfaces must be used to access these different services and a number of subscriptions to different parties must be maintained to have access to their respective content and services.

One typical configuration used to provide such content and services to end users is called the “last mile” configuration. A broadband service system is positioned on the broadband network to provide services to a localised group of user terminals. The distance between the user terminals and the broadband service system is minimized to reduce delays and so forth associated with large transmission distances within the network. It will be appreciated that in order to implement the “last mile” configuration, a large number of broadband service systems will be required, each to provide services to a localised area. However, by providing services using the “last mile” configuration, a service provider introduces a level of complexity to himself and to content providers because each individual system must be maintained and updated. This problem is further exacerbated if different content and services are to be offered on different systems.

The present invention seeks to provide a method and system for providing and managing content on a broadband network that avoids the above mentioned problems.

### STATEMENT OF THE INVENTION

According to one aspect of the present invention, there is provided a broadband system for providing access to content to a number of user terminals, the system storing the content and having a database of information, at least some of which information concerns the content, and being arranged to allow access by user terminals to the content in dependence on the information, wherein the system is arranged to receive new or updated content with associated metadata, the metadata containing data on the new or updated content, the system being arranged to store information derived from the metadata in the database for the received new or updated content, thereby allowing access to the content by user terminals.

The metadata may comprise data fields and corresponding data values, wherein at least some of the data values contain data about the content. The metadata may be an extended mark-up language, XML, file. The metadata may include data fields and corresponding data values for a content provider ID, a content ID, the content's category, the content's title, a description of the content and a price for accessing the content. The metadata may include optional data fields and corresponding data values for storing data about the content to be provided to a user. At least some of the metadata may be dependent on the data format of the content. At least some of the metadata may be dependent on a service selected to distribute the content to user terminals. At least some of the metadata may include instructions to the system relating to the storage of the content, wherein the system is arranged to store the content in dependence on the instructions. The system may include a plurality of storage units for storing content, wherein the instructions indicate a storage unit in which it is desired to store the content. The system may include a plurality of types of storage units for storing content, wherein the instructions indicate a type of storage unit in which it is desired to store the content.

The system may be in communication with one or more other broadband systems, wherein at least some of the metadata includes instructions to the system relating to the distribution of the content, wherein the system is arranged to distribute the content and metadata to the other broadband systems in dependence on the instructions.

The system may be in communication with another broadband system, each broadband system having an identifier, wherein the system is arranged to receive identifiers of the broadband systems in which the content is to be stored with the content, wherein upon receipt of content, metadata and identifiers, the system is arranged to check the identifiers for its identifier and, if its identifier is found, to store the content, to store information derived from the metadata in the database, the system being arranged to delete its identifier from the identifiers once the content and information derived from the metadata is stored, wherein if the identifiers include further identifiers, the system is arranged to communicate the content and metadata to the other broadband system.

The metadata may include the identifiers of the broadband systems in which the content is to be stored.

The system may further comprise a storage unit for storing the content.

The storage unit may be a selected one of: a hard disk, a disk array, a removable disk, a CD disk, a memory, a DVD disk, an optical storage device and a floppy disk.

The system may be arranged to receive a delete command specifying content to be deleted, wherein upon receipt of the delete command the system is operative to delete the content and to remove the information derived from the metadata associated with the content from the database.

The system may be in communication with one or more broadband systems, wherein the system is arranged to distribute received content and metadata to the other broadband systems.

The system may further comprise a billing unit, the billing unit being arranged to charge for content providers for the storage of content. The billing unit may be arranged to calculate the amount of content stored for a content provider over a predetermined period of time and charge the content provider in dependence on the calculated amount. The system may include a number of storage units for storing content, each storage unit having different characteristics, the content provider being able to determine the storage unit in which content is stored, wherein the billing unit may be arranged to charge the content provider for storing content in dependence on the storage unit storing the content. The billing unit may be arranged to charge the content provider for storing content in dependence on the content type stored. The metadata may include a charge to be paid to the content provider by a user for accessing the content, wherein billing unit is arranged to charge the content provider a percentage of the charge for storing the content.

The system may further comprise a further broadband system storing content and storing information derived from associated metadata in a database, the system comprising search module arranged to accept a search term from a user terminal, wherein the search module is arranged to communicate with the further broadband system providing access to content to a number of user terminals, the search module being arranged to obtain information substantially matching to the search term from the further broadband system's database, to report obtained information to the user terminal and to accept requests for content associated with a selected one of the obtained information from the user terminal, wherein upon acceptance of a request for content, the search module is arranged to obtain the content associated with the selected information from the further broadband system and information associated with the content from the further broadband system's database and to store the content and to store the information associated with the content in the system's database for subsequent access by a user terminal.

The system may further comprise a remote storage system arranged to store content and having a database for storing information derived from associated metadata, wherein the search module is arranged to communicate with the remote storage system, the search module being arranged to obtain information substantially matching to the search term from the remote storage system's database, to report obtained information to the user terminal and to accept requests for content associated with a selected one of the obtained information from the user terminal, wherein upon acceptance of a request for content, the search module is arranged to obtain the content associated with the selected information from the remote storage system and information associated with the content from the remote storage system's database and to store the content and to store the information associated with the content in the system's database for subsequent access by a user terminal. The system may be arranged to transfer content and information in the database associated with the content to the remote storage system for storage under predetermined circumstances such as a request from the content's provider or determination that the content has not been accessed by user terminals for a predetermined period of time.

According to another aspect of the present invention, there is provided a method of providing access to content to a number of user terminals in a broadband network comprising the steps of:

storing content for access by the user terminals;

maintaining a database of information, at least some of which concerns the content;

allowing access by user terminals to the content in dependence on the information;

receiving new or updated content with associated metadata, the metadata containing data on the new or updated content;

storing the new or updated content; and,

storing information derived from the associated metadata in the database for the received new or updated content, thereby allowing access to the content by user terminals.

According to another aspect of the present invention, there is provided a method of providing access to content to a number of user terminals in a broadband network, the content being stored with a database of information, at least some of which concerns the content, access by user terminals to the content being dependent on the information, the method comprising the steps of: receiving new or updated content with associated metadata, the metadata containing data on the new or updated content; storing the new or updated content; and, storing information derived from the associated metadata in the database for the received new or updated content, thereby allowing access to the content by user terminals.

At least some of the metadata may include instructions relating to the storage of the content, the method may further comprise the step of storing the content in dependence on the instructions.

A plurality of storage units may be used to storing the content, the instructions indicating a storage unit in which it is desired to store the content, the step of storing the content may comprise the step of storing the content in the storage unit indicated by the instructions.

A plurality of types of storage units may be used to store content, the instructions indicating a type of storage unit in which it is desired to store the content, the step of storing the content may comprise the step of storing the content in a storage unit of the type indicated in the instructions.

According to another aspect of the present invention, there is provided a network of broadband systems for providing access to content to a number of user terminals, each user terminal accessing content via a predetermined one of the broadband systems, each broadband system storing content and having a database of information, at least some of which information concerns the content, and being arranged to allow access by user terminals to the content in dependence on the information, wherein each broadband system is arranged to receive new or updated content with associated metadata, the metadata containing data on the new or updated content, each system being arranged to store information derived from the metadata in the database for the received new or updated content, thereby allowing access to the content by user terminals.

Each system may be in communication with one or more of the other broadband systems, wherein at least some of the metadata includes instructions to the system relating to the distribution of the content, wherein a system receiving content and associated metadata being arranged to distribute the content and metadata to the other broadband system(s) in dependence on the instructions.

Each system may be in communication with another of the broadband systems, each broadband system having an identifier, wherein at least some of the metadata includes identifiers of the broadband systems in which the content is to be stored, wherein upon receipt of content and metadata each system is arranged to check the metadata for its identifier and to store the content, to store information derived from the metadata in the database if the identifier is found, the system being arranged to delete its identifier from the at least some of the metadata once the content and information derived from the metadata is stored, wherein if the at least some of the metadata includes further identifiers, the system is arranged to communicate the content and metadata to other broadband system.

The network may further comprise a distribution system in communication with each of the broadband systems, the distribution system being arranged to receive content and associated metadata and to communicate the content and metadata to each of the broadband systems.

Each system may include a search module is arranged to communicate with others of the broadband systems, the search module being arranged to obtain information substantially matching to the search term from the other broadband systems databases, to report obtained information to the user terminal and to accept requests for content associated with a selected one of the obtained information from the user terminal, wherein upon acceptance of a request for content, the search module is arranged to obtain the content associated with the selected information from the respective other broadband system and information associated with the content from the respective other broadband system's database and to store the content and to store the information associated with the content in the system's database for subsequent access by a user terminal.

The network may further comprise a remote storage system arranged to store content and having a database for storing information derived from associated metadata, wherein the search module of one of the broadband systems is arranged to communicate with the remote storage system, the search module being arranged to obtain information substantially matching to the search term from the remote storage system's database, to report obtained information to the user terminal and to accept requests for content associated with a selected one of the obtained information from the user terminal, wherein upon acceptance of a request for content, the search module is arranged to obtain the content associated with the selected information from the remote storage system and information associated with the content from the remote storage system's database and to store the content and to store the information associated with the content in the system's database for subsequent access by a user terminal.

Each broadband system may be arranged to transfer content and information in the database associated with the content to the remote storage system for storage under predetermined circumstances such as a request from the content's provider or determination that the content has not been accessed by user terminals for a predetermined period of time.

According to another aspect of the present invention, there is provided a broadband system for providing access to content to a number of user terminals, the system having a database of information, at least some of which information concerns the content, and being arranged to allow access by user terminals to the content in dependence on the information, wherein the system is arranged to receive metadata on new or updated content and to store information derived from the metadata in the database for the received new or updated content, thereby allowing access to the content by user terminals.

According to another aspect of the present invention, there is provided a computer readable medium, on which is stored a computer program of instructions for controlling a general purpose computer to provide access to content to a number of user terminals, comprising, in combination:

means for enabling the computer to store the content;

means for enabling the computer to store a database of information, at least some of which information concerns the content;

means for enabling the computer to allow access by user terminals to the content in dependence on the information;

means for enabling the computer to receive new or updated content with associated metadata, the metadata containing data on the new or updated content; and,

means for enabling the computer to store information derived from the metadata in the database for the received new or updated content, thereby allowing access to the content by user terminals.

According to a further aspect of the present invention, there is provided a computer readable medium, on which is stored a computer program of instructions for controlling a general purpose computer to provide access to content to a number of user terminals, the computer storing the content and having a database of information, at least some of which information concerns the content, access by user terminals to the content being in dependence on the information, the computer program of instructions comprising, in combination:

means for enabling the computer to receive new or updated content with associated metadata, the metadata containing data on the new or updated content; and,

means for enabling the computer to store information derived from the metadata in the database for the received new or updated content, thereby allowing access to the content by user terminals.

According to another aspect of the present invention, in a broadband system providing access to content to a number of user terminals, the system storing the content and having a database of information, at least some of which information concerns the content, access by user terminals to the content being in dependence on the information, there is provided a content deployment system for providing content to the broadband system comprising an interface operative to accept pre-generated content and metadata on the content; and,

a transmission system operative to transmit the content and metadata to the broadband system for storage, information derived from the metadata being stored in the database.

According to a further aspect of the present invention, in a network of broadband systems, each system providing access to content to a number of user terminals, each system storing the content and having a database of information, at least some of which information concerns the content, access by user terminals to the content being in dependence on the information, there is provided a content deployment system for providing content to the network comprising:

an interface operative to accept pre-generated content and metadata on the content; an interface operative to accept one or more inputs corresponding to broadband systems on which the content is to be stored; and,

a transmission system operative to transmit the content and metadata to the broadband system(s) corresponding to the one or more inputs for storage, information derived from the metadata being stored in the database or databases of the system or systems.

The interface may be operative to determine the type of pre-generated content and provides a number of fields for input of data in dependence on the type, wherein the interface is operative to generate the metadata in dependence on the input data.

According to a further aspect of the present invention, there is provided a computer readable medium, on which is stored a computer program of instructions for controlling a general purpose computer to a content deployment system for providing content to a network of broadband systems, each system providing access to content to a number of user terminals, each system storing the content and having a database of information, at least some of which information concerns the content, access by user terminals to the content being in dependence on the information, comprising, in combination:

means for enabling the computer to provide an interface operative to accept pre-generated content and metadata on the content;

means for enabling the computer to provide an interface operative to accept one or more inputs corresponding to broadband systems on which the content is to be stored; and,

means for enabling the computer to transmit the content and metadata to the broadband system(s) corresponding to the one or more inputs for storage, information derived from the metadata being stored in the database or databases of the system or systems.

According to another aspect of the present invention, there is provided a computer readable medium, on which is stored a computer program of instructions for controlling a general purpose computer to provide a content deployment system for providing content to a broadband system providing access to content to a number of user terminals, the system storing the content and having a database of information, at least some of which information concerns the content, access by user terminals to the content being in dependence on the information, comprising, in combination:

means for enabling the computer to provide an interface operative to accept pre-generated content and metadata on the content; and,

means for enabling the computer to transmit the content and metadata to the broadband system for storage, information derived from the metadata being stored in the database.

The broadband system allows content to be uploaded and registered in a database on the basis of associated metadata. Access to the content from user terminals is via a user interface generated in dependence on the data in the database. Thus, uploading new content does not require any change to the user interface program as it adapts the user interface based on the changes to the database. The system offers a level of flexibility and power previously unseen in broadband service systems.

### BRIEF DESCRIPTION OF THE DRAWINGS

Examples of the present invention will now be described in detail, with reference to the accompanying drawings, in which:

FIG. 1 is a schematic diagram of a broadband network incorporating a system according to one embodiment of the present invention;

FIG. 2 is a schematic diagram of FIG. 1 with selected features illustrated in more detail;

FIG. 3 is an example of a metadata file for use in the present invention;

FIG. 4 is a screen shot showing a content deployment application for use in the present invention;

FIG. 5 is a schematic diagram incorporating a number of systems according to an embodiment of the present invention; and,

FIG. 6 is a schematic diagram of a broadband network incorporating a number of systems according to a further embodiment of the present invention.

### DETAILED DESCRIPTION

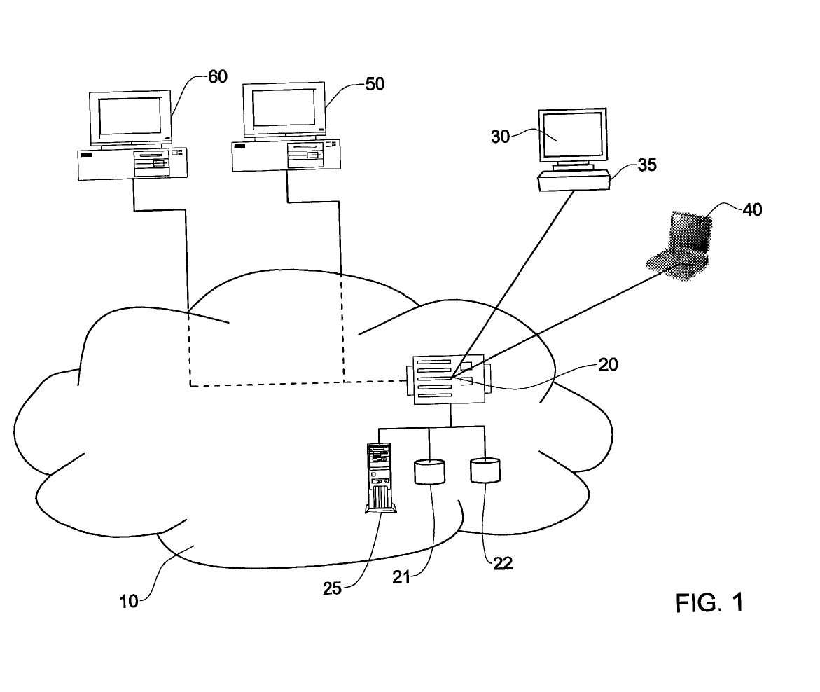

FIG. 1 is a schematic diagram of a broadband network incorporating a system according to an embodiment of the present invention. A broadband service system 20 is connected to a broadband network 10 and hosts content in the form of digital data and services for a number of user terminals (30, 35; 40). The system 20 includes a service database 21 and a content database 22. The system 20 also includes a memory 25, for example a hard disk or other storage medium.

The service database 21 and content database do not need to be separate entities and could be tables or collections of tables within a single database.

Using a user terminal such as a set-top-box 35 connected to a television 30 or a personal computer 40 equipped to access the broadband network 10, a user can access the content and services provided by the system 20. For example, the content and services may include: video on demand; games on demand; music on demand; multi media streaming; video chat; application service provision; software on demand; interactive TV; terrestrial, satellite and digital television; karaoke on demand; security applications such as remote camera monitoring; video conferencing; remote data storage; e-learning; and virtual private network access. In each case, a user uses the user terminal (30, 35; 40) to access the system 20. The service database 21 and content database 22 includes details of the content and services currently available on the system 20. In dependence on the contents of the two databases, a user is provided with an interface allowing access to available services and content. The services and content may be stored locally within the memory 25 or may be on a remote system (not shown) accessible by the system 20. The location of the services and content are stored within the respective databases (20,21). When a user elects to access content or a service, a connection between the respective user terminal and the location of the content or service is made and the service or content is provided to the user.

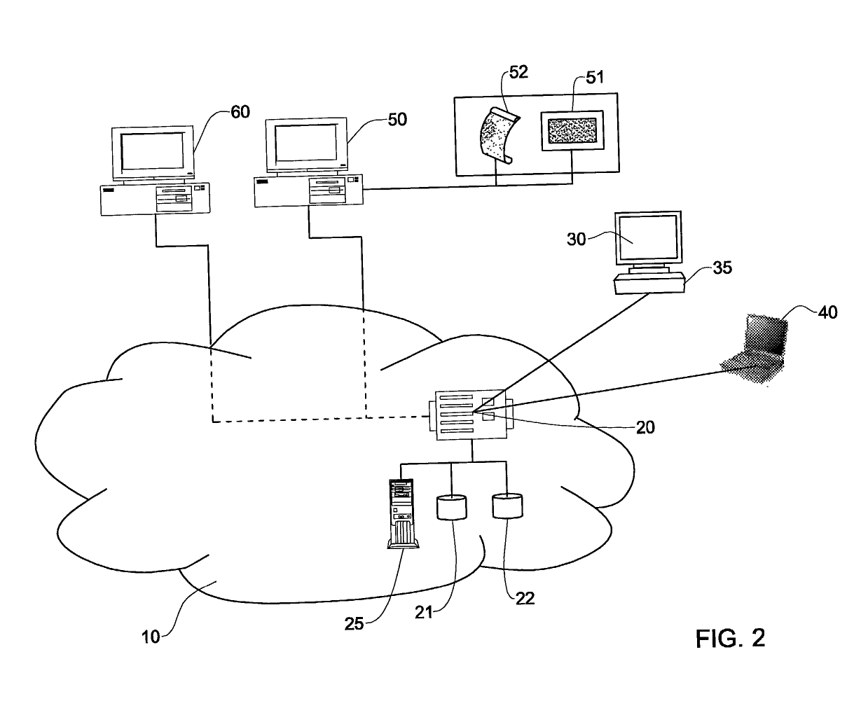

The system 20 allows content providers 50 to generate and maintain their own content and to make it available to users of the system 20. A content provider 50 is able to access the system 20 via the broadband network 10. Upon accessing the system 20, a content provider is able to upload new or changed content to the memory 25 and change, add or delete entries within the content database 22. FIG. 2 is the schematic diagram of FIG. 1 illustrating aspects of content maintenance and uploading in more detail. Content 51, for example a movie to be supplied using a video on demand service, is generated by a content provider 50. When generating the content 51 to be hosted by the system 20, the content provider 50 also generates a metadata file 52 relating to the content 51. The metadata file 52 includes fields defining the title and format of the content 51 along with data to be provided to a user via the user interface. The data may include the author of the content, actors, the genre, age ratings and so forth. The exact metadata fields for a specific content depends on the content type and the data the content provider wishes to provide.

The metadata must include a number of fields that allow the system 20 to register the content in the content database 22 and provide the content to the user terminals (30, 35; 40). These mandatory metadata fields include:

| FIELD | FIELD CONTENT |
|---|---|
| Content provider ID | ID of the content provider as known by |
| | the system 20 |
| Content ID | ID code by which the content is to be |
| | known as within the system |
| Category | The category and/or genre for the content |
| Title | Title of the content to be displayed to the |
| | user |
| Description | Description of the content to be provided |
| | to the user when previewing the content |
| Pricing | Price or pricing scheme to be applied for |
| | a user accessing the content |

Further, optional, metadata fields may also be specified. These may include a path to the content on the system or on a remote system, pictures to be displayed to the user when previewing the content, specific command line parameters to be used to start the content and specific service applications to be used to access the content. Depending on the content type and an intended service to be used to provide the content, other service or format-specific fields may be mandatory or optional. Examples of format-specific fields for video type content formats include frame rate, encoding mechanism, maximum bit rate, minimum bit rate, and the application to be used to output the content on the user's terminal.

Examples of other fields that may be included in the metadata include language of the content, dates of creation, issue, modification, creator, publisher, contributor, author, encryption or encoding format, user terminal requirements, intellectual property rights, and files of the content.

Having preparing the content 51 and metadata file 52, the content provider 50 uploads these to the system 20. Upon receiving the content 51 and metadata file 52, the system 20 creates a new entry within the content database 22 and registers the metadata file within the database. The content file itself is stored in the memory 25.

If a content provider 50 wishes to update content already held on a system 20 or to change the metadata or temporarily make the content unavailable, he or she merely needs to update the metadata file and upload this along with any updated content to the server. By using the same content ID, existing content is amended or overwritten accordingly.

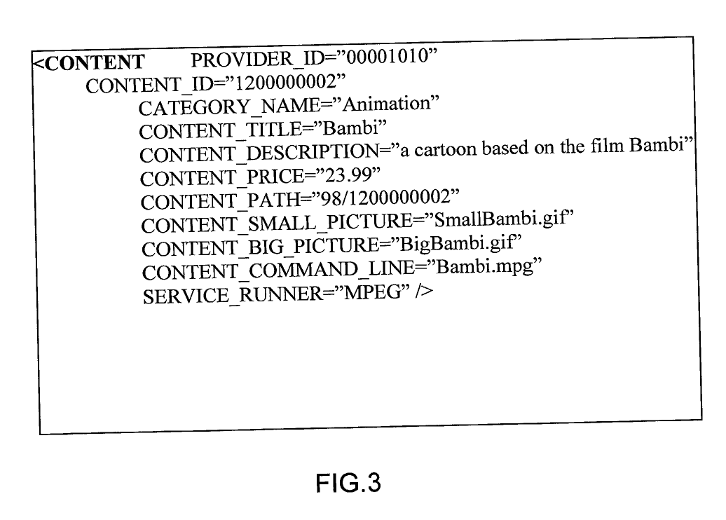

The XML message structure is currently found to be most convenient for generating metadata files. However, any suitable message structure could also be used. An example of a metadata file is shown in FIG. 3. The file defines an animation called “Bambi” having an identity on the system of 1200000002 and an access price of $23.99. The content is described as being “a cartoon based on the film Bambi” and is stored in a directory on the system 20 having the path 98/1200000002. A number of pictures are defined that can be displayed to a user when previewing the animation and the content file itself is called “Bambi.mpg”.

A system receiving a metadata file such as that illustrated with reference to FIG. 3 processes the field content of the metadata fields and stores the content in corresponding fields of a record in its database. If the metadata fields include, for example, instructions to the system on where to store the content or how to subsequently distribute it to other systems, these fields might not be stored in the database, instead the system may take actions to carry out the instructions and then discard the data content from those fields.

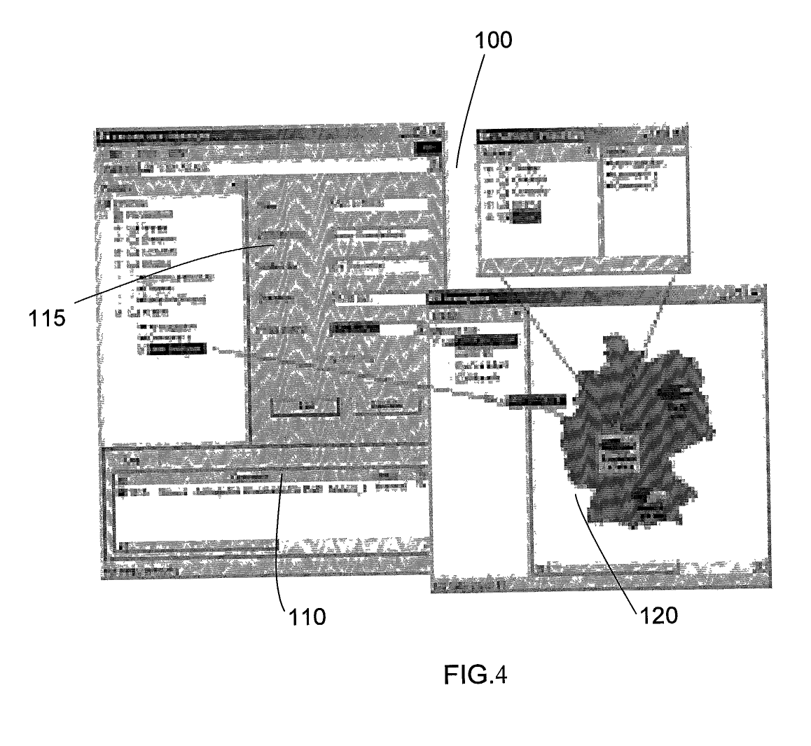

Preferably, the content provider 50 is provided with a software application that guides the content provider 50 through the steps of generating the metadata and uploading the metadata and content to a system. An example application is described in more detail with reference to FIG. 4. FIG. 4 shows a screen shot of a number of windows from a content deployment application 100.

The content deployment application 100 includes a content entry window 110 and a content distribution window 120. Via the content entry window 110, a content provider can add new content to be uploaded to a system and enter metadata values for the content required by the system. The metadata values of existing content can be changed and new content files can also be added to augment or overwrite existing ones. When new content is added to the content entry window 110, the content type is determined or selected and an appropriate set of metadata fields are displayed in a portion 115 of the window 110. The content provider is then able to input the metadata into the fields to generate the metadata file for use by the system.

Once the metadata has been input, the content can be uploaded to a broadband service system. In the present example, uploading is triggered by dragging an icon representing the content onto a desired broadband service system graphically depicted on the content deployment window 120. However, any other mechanism could also be used, such as selecting “upload” from a button or menu or using a key combination.

Once a content provider 50 selects to upload content to a system, a metadata file in XML is generated based on the inputted metadata. The content and metadata file is then transmitted to the selected broadband service system over the broadband network via a data transmission protocol such as the File Transfer Protocol (FTP). Preferably, the progress of the upload process is graphically displayed by the content deployment window 120.

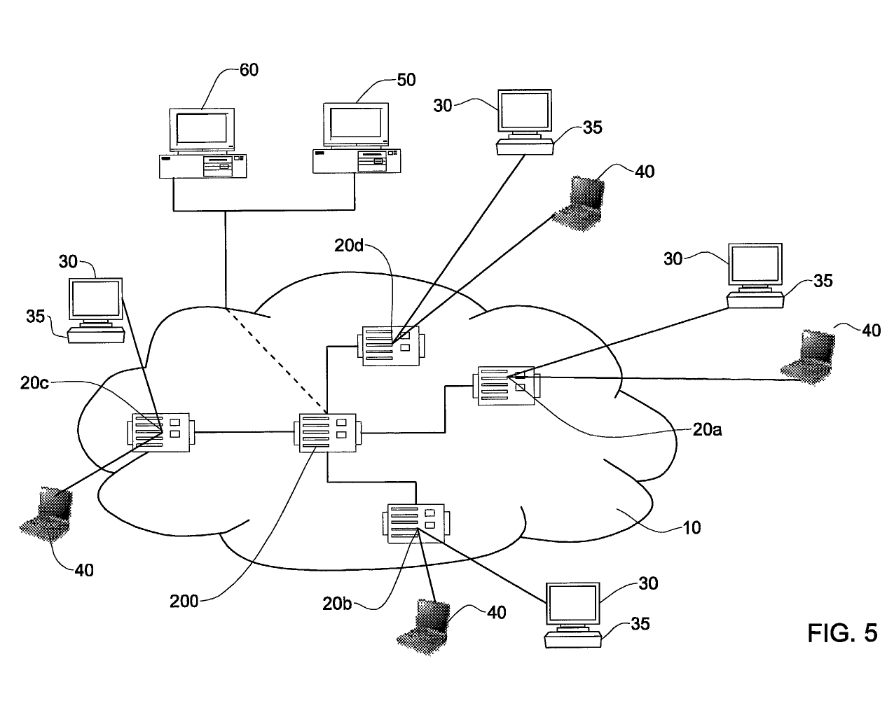

FIG. 5 is a schematic diagram of a broadband network 10 incorporating a number of broadband service systems according to an embodiment of the present invention. In order to address this problem of updating individual systems 20a-20d in a “last mile” configuration, a central management system 200 is connected to the broadband network and configured to communicate with content providers 50. Content providers 50 may upload content and associated metadata files directly to local systems 20a-20d. However, a content provider 50 may alternatively select to upload content and associated metadata files to the central management system 200. Metadata fields within the metadata file can be set to instruct the central management system 200 to distribute the content to one or more of the local servers 20a-20d. For example, a metadata field “Distribute” may be set to have values of “All” or to list the identities of local systems 20a-20d to which the content is to be distributed. Therefore, a content provider 50 can generate content and a single associated metadata file and upload it to the central system 200. Upon receipt, the central system 200 processes the metadata file to determine the values of the “Distribute” field and thus the local system(s) 20a-20d to which the content and file should be replicated. The central server then takes the necessary steps to replicate this data to the local systems 20 without any action being required on the part of the content provider. Upon receipt by a local system 20a-20d, the content is stored and registered in the system's content database in dependence on the content of the metadata file. Amendments to content and associated metadata files may be performed in a similar manner by submitting updated or amended content files and metadata files to the central system 200.

In another embodiment of the present invention (not specifically illustrated), a replication process may be applied in a distributed manner instead of having a central system 200. Each local system 20a-20d may be arranged to communicate with one or more other local systems 20a-20d. Upon receiving content and an associated metadata file, the local system 20a-20d processes the “Distribute” field in the metadata file to determine whether the content and metadata should be passed on to further local systems 20a-20d. Infinite loops can be avoided by having a local system remove its identifier from the “Distribute” field when it receives the content and metadata file so it does not receive it again. Alternatively, local systems may be arranged to only communicate with selected other local systems so no transmission loops occur. Other configurations based on known data networking techniques will be apparent to the skilled reader.

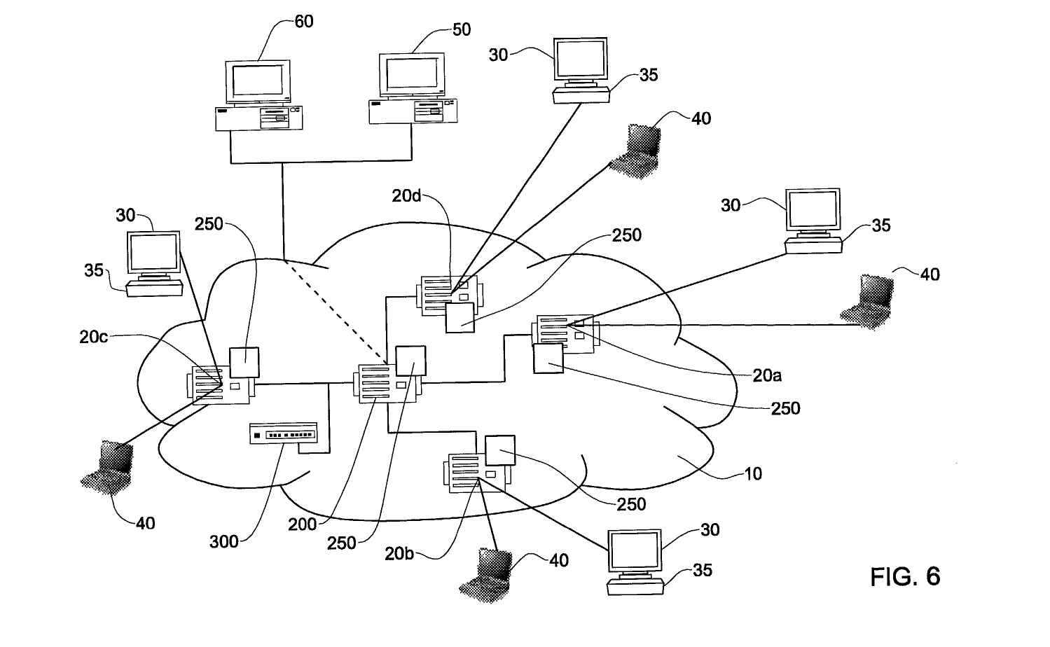

FIG. 6 is a broadband network 10 incorporating a number of broadband service systems according to another embodiment of the present invention. In a similar manner to the configuration described with reference to FIG. 5, a broadband network may include a number of local broadband service platforms 20a-20d offering “last mile” service. However, for irregularly accessed content and for content providers wishing to initially reduce billing charges for storage of their content on the broadband service systems 20a-20d, the present configuration offers a distribution on demand option. Content can be distributed in a manner described with reference to the proceeding Figures. However, one or more of the metadata fields may allow the content provider to specify that content may be distributed on demand. Local systems 20a-20d may include a search module 250 that is able to access the content databases of other systems 20a-20d to obtain metadata on the content stored on those systems. Via a user terminal (30, 35; 40), the local system's user interface allows a user to access the search module 250 to search for specific content. Preferably, seraching is performed by transmitting an XML file containing metadata corresponding to the query to each system. Upon receipt, of a query, a system compares the metadata with its database and returns an XML file of metadata corresponding to records in the database that match the metadata in the search query. If content is found that the user wishes to access, the user may instruct the local system 20a-20d to obtain a copy of the content. For example, a local system 20a receiving such an instruction communicates with the system 20c storing the content to arrange transmission of the content and its associated metadata file so that it may be provided to the user terminal 40 from the local system 20a at a slightly later time.

This configuration may be further expanded to have content storage systems 300 removed from frontline user access to reduce storage costs of infrequently requested content but to retain this content online for access. Storage systems 300 do not offer a user interface or even have the necessary hardware and software to offer access from user terminals. Instead, the storage systems 300 are configured to receive and store content, registering metadata in a database in the same manner as local systems 20, to reply to search queries and to transmit content and metadata files on demand within the broadband network 10. A storage system is preferably a significantly cut-down version of the broadband service systems 20a-20d having reduced purchase and maintenance costs that can be passed on to content providers in the form of reduced content storage charges. Local broadband service systems 20a-20d may be arranged to move content and their associated metadata files to such storage systems 300 if access of the content drops below a predetermined threshold over a set period or the content becomes older than a predetermined age. Content providers may also be given the option of uploading content directly to such storage systems 300.

In combination, the central system 200, local systems 20a-20d and content deployment application may be configured to allow scheduled uploading and duplication. Furthermore, the central system 200 and local systems 20a-20d may be configured to mirror each other removing the need to explicitly update content on each system 20a-20d.

Many different charging schemes may be envisaged. For example, a content provider may be charged per unit of storage device consumed by content on broadband service systems. If different storage devices are available, for example devices dedicated to video streaming having better access rates and sustainable bit-rates that conventional storage devices, these may be selected by a content provider on uploading content in the same way as different broadband service systems can be selected. A content provider may be charged at different rates depending on the storage device uploaded to. Preferably, the charging is based on the amount of time content is held by a system, thus allowing content on demand to be charged appropriately.

Charging may also be made on the basis of the content type stored. For example, interactive games only generate sporadic network traffic between the service system and a user terminal whilst video on demand generates continuous network traffic and could be charged at a proportionately higher rate. Charging could also be made on the basis of a percentage of a content provider's charge to a user for accessing the content.

Whilst the above examples have been described with reference to specific user terminals, network configurations and database schema, it will be appreciated that the present invention is applicable to existing and future variations. For example, the databases may be combined to form separate tables in a single database or split into multiple databases, possibly hosted by different computer systems.

Furthermore, it will be appreciated from the above description that the present invention provides a system that allows new content to be uploaded and provided to user terminals by remote content providers without any interfacing and development on the part of the service providers or the party maintaining the services system. The present invention is applicable to any type of content provision over broadband networks and can operate over any transport medium. Furthermore, whilst specific hardware is advisable for performance and quality of service issues, the present invention can operate on any computer platform that can communicate over a broadband network and is therefore very versatile.

The system 20 is not limited to specific platform types or user terminal types and could be implemented for user terminals ranging from, for example, desktop computers to mobile telephones.

1. A broadband system for providing access to content to a number of user terminals, the system storing the content and having a database of information, at least some of which information concerns the content, and being arranged to allow access by user terminals to the content in dependence on the information, wherein the system is arranged to receive new or updated content with associated metadata, the metadata containing data on the new or updated content, the system being arranged to store information derived from the metadata in the database for the received new or updated content, thereby allowing access to the content by user terminals.

2. A system according to claim 1, in which the metadata comprises data fields and corresponding data values, wherein at least some of the data values contain data about the content.

3. A system according to claim 2, in which the metadata is an extended mark-up language, XML, file.

4. A system according to claim 2, in which the metadata includes data fields and corresponding data values for a content provider ID, a content ID, the content's category, the content's title, a description of the content and a price for accessing the content.

5. A system according to claim 2, in which the metadata includes optional data fields and corresponding data values for storing data about the content to be provided to a user.

6. A system according to claim 1, wherein at least some of the metadata is dependent on the data type of the content.

7. A system according to claim 1, wherein at least some of the metadata is dependent on a service selected to supply the content to user terminals.

8. A system according to claim 1, wherein at least some of the metadata includes instructions to the system relating to the storage of the content, wherein the system is arranged to store the content in dependence on the instructions.

9. A system according to claim 8, wherein the system includes a plurality of storage units for storing content, wherein the instructions indicate a storage unit in which it is desired to store the content.

10. A system according to claim 8, wherein the system includes a plurality of types of storage units for storing content, wherein the instructions indicate a type of storage unit in which it is desired to store the content.

11. A system according to claim 1, wherein the system is in communication with one or more other broadband systems, wherein at least some of the metadata includes instructions to the system relating to the distribution of the content, wherein the system is arranged to distribute the content and metadata to the other broadband systems in dependence on the instructions.

12. A system according to claim 1, wherein the system is in communication with another broadband system, each broadband system having an identifier, wherein the system is arranged to receive identifiers of the broadband systems in which the content is to be stored with the content, wherein upon receipt of content, metadata and identifiers, the system is arranged to check the identifiers for its identifier and, if its identifier is found, to store the content, to store information derived from the metadata in the database, the system being arranged to delete its identifier from the identifiers once the content and information derived from the metadata is stored, wherein if the identifiers include further identifiers, the system is arranged to communicate the content and metadata to the other broadband system.

13. A system according to claim 12, in which the metadata includes the identifiers of the broadband systems in which the content is to be stored.

14. A system according to claim 1, further comprising a storage unit for storing the content.

15. A system according to claim 14, in which the storage unit comprises a selected one of: a hard disk, a disk array, a removable disk, a CD disk, a memory, a DVD disk, an optical storage device and a floppy disk.

16. A system according to claim 1, in which the system is arranged to receive a delete command specifying content to be deleted, wherein upon receipt of the delete command the system is operative to delete the content and to remove the information derived from the metadata associated with the content from the database.

17. A system according to claim 1, wherein the system is in communication with one or more broadband systems, wherein the system is arranged to distribute received content and metadata to the other broadband systems.

18. A system according to claim 1, further comprising a billing unit, the billing unit being arranged to charge for content providers for the storage of content.

19. A system according to claim 18, in which the billing unit is arranged to calculate the amount of content stored for a content provider over a predetermined period of time and charge the content provider in dependence on the calculated amount.

20. A system according to claim 18, in which the system includes a number of storage units for storing content, each storage unit having different characteristics, the content provider being able to determine the storage unit in which content is stored, wherein the billing unit is arranged to charge the content provider for storing content in dependence on the storage unit storing the content.

21. A system according to claim 18, in which the billing unit is arranged to charge the content provider for storing content in dependence on the content type stored.

22. A system according to claim 18, in which the metadata includes a charge to be paid to the content provider by a user for accessing the content, wherein billing unit is arranged to charge the content provider a percentage of the charge for storing the content.

23. A system according to claim 1, further comprising a further broadband system storing content and storing information derived from associated metadata in a database, the system comprising search module arranged to accept a search term from a user terminal, wherein the search module is arranged to communicate with the further broadband system providing access to content to a number of user terminals, the search module being arranged to obtain information substantially matching to the search term from the further broadband system's database, to report obtained information to the user terminal and to accept requests for content associated with a selected one of the obtained information from the user terminal, wherein upon acceptance of a request for content, the search module is arranged to obtain the content associated with the selected information from the further broadband system and information associated with the content from the further broadband system's database and to store the content and to store the information associated with the content in the system's database for subsequent access by a user terminal.

24. A system according to claim 23, further comprising a remote storage system arranged to store content and having a database for storing information derived from associated metadata, wherein the search module is arranged to communicate with the remote storage system, the search module being arranged to obtain information substantially matching to the search term from the remote storage system's database, to report obtained information to the user terminal and to accept requests for content associated with a selected one of the obtained information from the user terminal, wherein upon acceptance of a request for content, the search module is arranged to obtain the content associated with the selected information from the remote storage system and information associated with the content from the remote storage system's database and to store the content and to store the information associated with the content in the system's database for subsequent access by a user terminal.

25. A system according to claim 24, wherein the system is arranged to transfer content and information in the database associated with the content to the remote storage system for storage under predetermined circumstances.

26. A system according to claim 25, in which the predetermined circumstances include a selected one of: a request from an authorised party and determination that the content has not been accessed by user terminals for a predetermined period of time.

27. A method of providing access to content to a number of user terminals in a broadband network comprising the steps of:
storing content for access by the user terminals;
maintaining a database of information, at least some of which concerns the content;
allowing access by user terminals to the content in dependence on the information;
receiving new or updated content with associated metadata, the metadata containing data on the new or updated content;
storing the new or updated content; and,
storing information derived from the associated metadata in the database for the received new or updated content, thereby allowing access to the content by user terminals.

28. A method of providing access to content to a number of user terminals in a broadband network, the content being stored with a database of information, at least some of which concerns the content, access by user terminals to the content being dependent on the information, the method comprising the steps of:
receiving new or updated content with associated metadata, the metadata containing data on the new or updated content;
storing the new or updated content; and,
storing information derived from the associated metadata in the database for the received new or updated content, thereby allowing access to the content by user terminals.

29. A method according to claim 28, wherein at least some of the metadata includes instructions relating to the storage of the content, the method further comprising the step of storing the content in dependence on the instructions.

30. A method according to claim 29, wherein a plurality of storage units are used to storing the content, the instructions indicating a storage unit in which it is desired to store the content, the step of storing the content comprising the step of storing the content in the storage unit indicated by the instructions.

31. A method according to claim 29, wherein a plurality of types of storage units are used to store content, the instructions indicating a type of storage unit in which it is desired to store the content, the step of storing the content comprising the step of storing the content in a storage unit of the type indicated in the instructions.

32. A method according to claim 28, further comprising the step of charging content providers for the storage of content.

33. A method according to claim 32, in which the step of charging comprises the steps of calculating the amount of content stored for a content provider over a predetermined period of time and charging the content provider in dependence on the calculated amount.

34. A method according to claim 32, in which content is stored in a number of storage units, each storage unit having different characteristics, the content provider being able to determine the storage unit in which content is stored, wherein the step of charging comprises the step of charging in dependence on the storage unit storing the content.

35. A method according to claim 32, in which the step of charging comprises the step of charging in dependence on the content type stored.

36. A method according to claim 32, in which the metadata includes a charge to be paid by a user for accessing the content, wherein the step of charging comprises the step of charging a percentage of the charge for storing the content.

37. A network of broadband systems for providing access to content to a number of user terminals, each user terminal accessing content via a predetermined one of the broadband systems, each broadband system storing content and having a database of information, at least some of which information concerns the content, and being arranged to allow access by user terminals to the content in dependence on the information, wherein each broadband system is arranged to receive new or updated content with associated metadata, the metadata containing data on the new or updated content, each system being arranged to store information derived from the metadata in the database for the received new or updated content, thereby allowing access to the content by user terminals.

38. A network according to claim 37, wherein each system is in communication with one or more of the other broadband systems, wherein at least some of the metadata includes instructions to the system relating to the distribution of the content, wherein a system receiving content and associated metadata being arranged to distribute the content and metadata to the other broadband system(s) in dependence on the instructions.

39. A network according to claim 37, wherein each system is in communication with another of the broadband systems, each broadband system having an identifier, wherein at least some of the metadata includes identifiers of the broadband systems in which the content is to be stored, wherein upon receipt of content and metadata each system is arranged to check the metadata for its identifier and to store the content, to store information derived from the metadata in the database if the identifier is found, the system being arranged to delete its identifier from the at least some of the metadata once the content and information derived from the metadata is stored, wherein if the at least some of the metadata includes further identifiers, the system is arranged to communicate the content and metadata to other broadband system.

40. A network according to claim 37, further comprising a distribution system in communication with each of the broadband systems, the distribution system being arranged to receive content and associated metadata and to communicate the content and metadata to each of the broadband systems.

41. A network according to claim 37, wherein each system includes a search module is arranged to communicate with others of the broadband systems, the search module being arranged to obtain information substantially matching to the search term from the other broadband systems databases, to report obtained information to the user terminal and to accept requests for content associated with a selected one of the obtained information from the user terminal, wherein upon acceptance of a request for content, the search module is arranged to obtain the content associated with the selected information from the respective other broadband system and information associated with the content from the respective other broadband system's database and to store the content and to store the information associated with the content in the system's database for subsequent access by a user terminal.

42. A network according to claim 40, further comprising a remote storage system arranged to store content and having a database for storing information derived from associated metadata, wherein the search module of one of the broadband systems is arranged to communicate with the remote storage system, the search module being arranged to obtain information substantially matching to the search term from the remote storage system's database, to report obtained information to the user terminal and to accept requests for content associated with a selected one of the obtained information from the user terminal, wherein upon acceptance of a request for content, the search module is arranged to obtain the content associated with the selected information from the remote storage system and information associated with the content from the remote storage system's database and to store the content and to store the information associated with the content in the system's database for subsequent access by a user terminal.

43. A network according to claim 42, wherein each broadband system is arranged to transfer content and information in the database associated with the content to the remote storage system for storage under predetermined circumstances.

44. A network according to claim 43, in which the predetermined circumstances include a selected one of: a request from an authorised partyand determination that the content has not been accessed by user terminals for a predetermined period of time.

45. A broadband system for providing access to content to a number of user terminals, the system having a database of information, at least some of which information concerns the content, and being arranged to allow access by user terminals to the content in dependence on the information, wherein the system is arranged to receive metadata on new or updated content and to store information derived from the metadata in the database for the received new or updated content, thereby allowing access to the content by user terminals.

46. A computer readable medium, on which is stored a computer program of instructions for controlling a general purpose computer to provide access to content to a number of user terminals, comprising, in combination:
means for enabling the computer to store the content;
means for enabling the computer to store a database of information, at least some of which information concerns the content;
means for enabling the computer to allow access by user terminals to the content in dependence on the information;
means for enabling the computer to receive new or updated content with associated metadata, the metadata containing data on the new or updated content; and,
means for enabling the computer to store information derived from the metadata in the database for the received new or updated content, thereby allowing access to the content by user terminals.

47. A computer readable medium, on which is stored a computer program of instructions for controlling a general purpose computer to provide access to content to a number of user terminals, the computer storing the content and having a database of information, at least some of which information concerns the content, access by user terminals to the content being in dependence on the information, the computer program of instructions comprising, in combination:
means for enabling the computer to receive new or updated content with associated metadata, the metadata containing data on the new or updated content; and,
means for enabling the computer to store information derived from the metadata in the database for the received new or updated content, thereby allowing access to the content by user terminals.

48. A program storage device readable by a machine and encoding a program of instructions for executing the method steps of claim 273.

49. A program storage device readable by a machine and encoding a program of instructions for executing the method steps of claim 28.

50. In a broadband system providing access to content to a number of user terminals, the system storing the content and having a database of information, at least some of which information concerns the content, access by user terminals to the content being in dependence on the information, a content deployment system for providing content to the broadband system comprises:
an interface operative to accept pre-generated content and metadata on the content; and,
a transmission system operative to transmit the content and metadata to the broadband system for storage, information derived from the metadata being stored in the database.

51. In a network of broadband systems, each system providing access to content to a number of user terminals, each system storing the content and having a database of information, at least some of which information concerns the content, access by user terminals to the content being in dependence on the information, a content deployment system for providing content to the network comprises:
an interface operative to accept pre-generated content and metadata on the content;
an interface operative to accept one or more inputs corresponding to broadband systems on which the content is to be stored; and,
a transmission system operative to transmit the content and metadata to the broadband system(s) corresponding to the one or more inputs for storage, information derived from the metadata being stored in the database or databases of the system or systems.

52. A content deployment system according to claim 49, in which the interface is operative to determine the type of pre-generated content and provides a number of fields for input of data in dependence on the type, wherein the interface is operative to generate the metadata in dependence on the input data.

53. A content deployment system according to claim 50, in which the interface is operative to determine the type of pre-generated content and provides a number of fields for input of data in dependence on the type, wherein the interface is operative to generate the metadata in dependence on the input data.

54. A computer readable medium, on which is stored a computer program of instructions for controlling a general purpose computer to a content deployment system for providing content to a network of broadband systems, each system providing access to content to a number of user terminals, each system storing the content and having a database of information, at least some of which information concerns the content, access by user terminals to the content being in dependence on the information, comprising, in combination:
means for enabling the computer to provide an interface operative to accept pre-generated content and metadata on the content;
means for enabling the computer to provide an interface operative to accept one or more inputs corresponding to broadband systems on which the content is to be stored; and,
means for enabling the computer to transmit the content and metadata to the broadband system(s) corresponding to the one or more inputs for storage, information derived from the metadata being stored in the database or databases of the system or systems.

55. A computer readable medium, on which is stored a computer program of instructions for controlling a general purpose computer to provide a content deployment system for providing content to a broadband system providing access to content to a number of user terminals, the system storing the content and having a database of information, at least some of which information concerns the content, access by user terminals to the content being in dependence on the information, comprising, in combination:
means for enabling the computer to provide an interface operative to accept pre-generated content and metadata on the content; and,
means for enabling the computer to transmit the content and metadata to the broadband system for storage, information derived from the metadata being stored in the database.
